(19) United States
(12) Patent Application Publication
(10) Pub. No.: US 2015/0149680 A1
(43) Pub. Date: May 28, 2015

(54) INFORMATION PROCESSING APPARATUS AND INFORMATION PROCESSING METHOD

(71) Applicant: Yoshimichi KANDA, Kanagawa (JP)

(72) Inventor: Yoshimichi KANDA, Kanagawa (JP)

(73) Assignee: Ricoh Company, Ltd., Tokyo (JP)

(21) Appl. No.: 14/476,799

(22) Filed: Sep. 4, 2014

(30) Foreign Application Priority Data
Nov. 27, 2013 (JP) 2013-245291
May 15, 2014 (JP) 2014-101447

(51) Int. Cl. G06F 13/30

(52) U.S. Cl. CPC G06F 13/30; G06F 2213/2804
USPC 710/308

(57) ABSTRACT

An information processing apparatus having first and second buses, includes: a read/write command unit transmitting a read command or a write command to the first bus; a read command unit receiving a read command from the second bus; a write command unit receiving a write command from the second bus; and a command unit transmit the read command and the write command to the read/write command unit based on the read and write commands received by the read command unit and the write command unit.

Further, the command unit stops transmitting the read command, and, while stopping transmission of the read command, change a transmission order of the read and the write commands so that the read/write command unit transmits the write command with higher priority than the read command.

### CROSS-REFERENCE TO RELATED APPLICATIONS

The present application is based on and claims the benefit of priority under 35 U.S.C §119 of Japanese Patent Application Nos. 2013-245291 filed Nov. 27, 2013 and 2014-101447 filed May 15, 2014, the entire contents of which are hereby incorporated herein by reference.

### BACKGROUND OF THE INVENTION

1. Field of the Invention

The present invention generally relates to an information processing apparatus and an information processing method.

2. Description of the Related Art

There has been used an interface circuit (a so-called “bus”) for connecting devices or electronic parts to each other in an electronic circuit of an information processing apparatus.

In order to improve the bus throughput, there is a known method in which the idle time in the transmission path on the transmitting side and the receiving side is reduced (see, for example, Japanese Laid-open Patent Publication No. 2008-250985).

### SUMMARY OF THE INVENTION

According to an aspect of the present invention, an information processing apparatus having first and second buses, includes

a read/write command unit transmitting a read command or a write command to the first bus;

a read command unit receiving a read command from the second bus;

a write command unit receiving a write command from the second bus; and

a command unit transmitting the read command and the write command to the read/write command unit based on the read command received by the read command unit and the write command received by the write command unit.

Further, the command unit
performs a stand-by process to stop transmitting the read command, and
performs a re-arranging process to, while stopping transmission of the read command, changes a transmission order of the read command and the write command so that the read/write command unit transmits the write command with higher priority than the read command.

### BRIEF DESCRIPTION OF THE DRAWINGS

Other objects, features, and advantages of the present invention will become more apparent from the following description when read in conjunction with the accompanying drawings, in which:

FIG. 1 illustrates an example image forming apparatus including an information processing apparatus according to an embodiment;

FIG. 2 is a block diagram of an example hardware configuration of an information processing apparatus according an embodiment;

FIG. 3 is a functional block diagram of an example information processing apparatus according to an embodiment;

FIG. 4 is a block diagram of an example configuration of a control ASIC according to an embodiment;

FIG. 5 is a block diagram of an example configuration of an interface conversion circuit according to an embodiment;

FIG. 6A illustrates an example command interface according to an embodiment;

FIG. 6B illustrates example signals from a command conversion circuit to a PCIe IP core;

FIG. 7 illustrates an example configuration of the PCIe IP core according to an embodiment;

FIG. 8 is a block diagram of an example of reception by the PCIe IP core according to an embodiment;

FIG. 9 is a timing chart illustrating an example stand-by process according to an embodiment;

FIG. 10 is a timing chart illustrating an example re-arranging process according to an embodiment;

FIG. 11 is a flowchart of an example of transmission and a re-arranging process according to an embodiment; and

FIG. 12 illustrates an example register of the control ASIC according to an embodiment.

### DETAILED DESCRIPTION OF THE PREFERRED EMBODIMENTS

In related technologies, there has been know a method to improve the bus throughput in an electronic circuit of an information processing apparatus (see, for example, Japanese Laid-open Patent Publication No. 2008-250985)

However, in such a method (e.g., Japanese Laid-open Patent Publication No. 2008-250985), there is a likelihood that the bus throughput may be reduced.

The present invention is made in light of the problem, and may provide an information processing apparatus where the throughput in reading and writing processes is improved when the information processing apparatus includes two separated buses and one common bus, one of the two separated buses being for inputting write commands and the other of the two separated buses being for inputting read commands, and the one common bus being for inputting both the write commands and read commands.

According to an embodiment, it becomes possible to reliably improve the bus throughput.

In the following, embodiments of the present invention are described with reference to the accompanying drawings.

A bus connects, for example, devices in an information processing apparatus such as an Integrated Circuit (IC) or electronic parts to each other. Further, A bus is a path to transmit and receive data between devices and electronic parts. Here, the IC refers to, for example, an Application Specific Integrated Circuit (ASIC) or a Central Processing Unit (CPU).

A bus includes, for example, a so-called “internal bus” and a so-called “expansion bus”. In this regard, the bus includes, for example, a Peripheral Component Interconnect (PCI) bus, and a PCI Express (PCIe) bus. The bus includes, for example, an Advanced eXtensible Interface (AXI) bus, an Industry Standard Architecture (ISA) bus, and an Accelerated Graphics Port (AGP) bus.

According to an embodiment, an information processing apparatus include, for example, a first bus and a second bus.

The term the “first bus” herein refers to a bus where a command input section for inputting a write command to perform a write command process and a command input section for inputting a read command to perform a read command process are common. The PCIe bus is an example of the first bus. In the following, the PCIe bus is described as an example of the first bus.

The term the “second bus” herein refers to a bus where a command input section for inputting a write command to perform a write command process and a command input section for inputting a read command to perform a read command process are separately provided. The AXI bus is an example of the second bus. In the following, the AXI bus is described as an example of the second bus.

### Outline

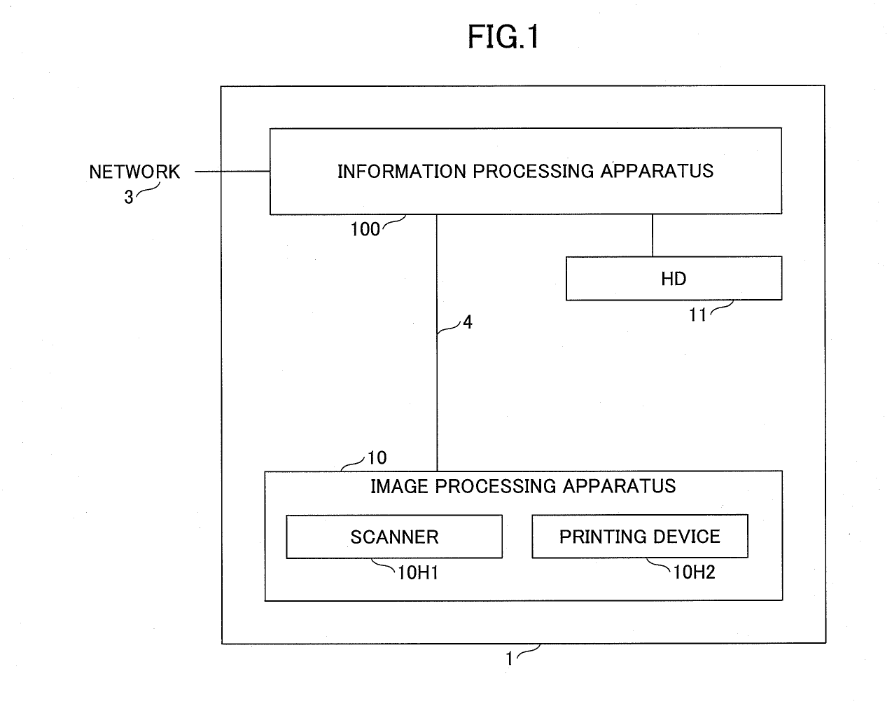

FIG. 1 schematically illustrates an example image forming apparatus including an information processing apparatus according to an embodiment.

As illustrated in FIG. 1, an image forming apparatus 1 includes an image processing apparatus 10 an a Hard Disk (HD) 11, and an information processing apparatus 100.

The image processing apparatus 10 and the information processing apparatus 100 are connected to each other via an external bus 4.

The HD 11 is an auxiliary storage device. The HD 11 stores data under the control of the information processing apparatus 100 described below. The stored data include, for example, image data described below.

The information processing apparatus 100 may be, for example, an electronic circuit board. The information processing apparatus 100 controls the image forming apparatus 1. To that end, for example, the information processing apparatus 100 causes the image processing apparatus 10 described below to perform a process to form an image. Further, the information processing apparatus 100 causes the image processing apparatus 10 to perform a process to read an image. Here, the HD 11 may be a flash Solid State Drive (flash SSD). Further, the HD 11 may be connected to the outside of the image forming apparatus 1 via, for example, a network 3 or an external bus (not shown).

Further, the information processing apparatus 100 is connected to the network 3 such as, for example, a Local Area Network (LAN) or the Internet. The information processing apparatus 100 accepts (receives) an input of a command, which is an instruction from an operator to the image forming apparatus 1, (hereinafter may be referred to as “command input”) and an input of image data via the network 3.

The image processing apparatus 10 includes an image input device such as a scanner 10H1. The scanner 10H1 reads an image formed on a sheet or stored in a recording medium, and generates the image data. The generated image data are stored in a storage section of the information processing apparatus 100 described below via the external bus 4.

The image processing apparatus 10 further includes an image output device such as a printing device 10H2. The printing device 10H2 performs an image forming process on a recording medium based on the image data stored in the information processing apparatus 100. The image data stored in the information processing apparatus 100 (i.e., the image data stored in the storage section of the information processing apparatus 100) are read to the printing device 10H2 via the external bus 4. Then, the external bus 4 performs the image forming process based on the read image data.

### Hardware Configuration of the Information Processing Apparatus 100

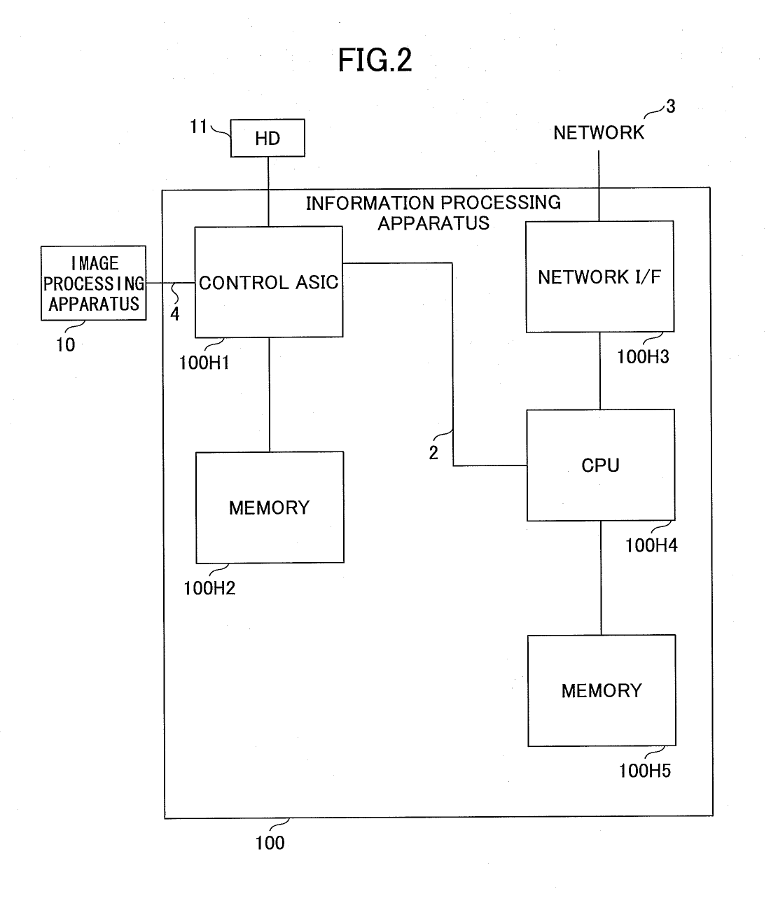

FIG. 2 illustrates an example hardware configuration of the information processing apparatus 100 according to an embodiment.

As illustrated in FIG. 2, the information processing apparatus 100 includes a control ASIC 100H1, a memory 100H2, a network interface (I/F) 100H3, a CPU 100H4, and a memory 100H5.

The control ASIC 100H1 is a device that controls the devices and buses. Details of the control ASIC 100H1 are described below.

The memory 100H2 is a main memory (main storage). The memory 100H2 is a storage that stores information such as data to be used in the calculations executed by the control ASIC 100H1, and is a so-called “Memory”. The memory 100H2 may be, for example, a Double-Data-Rate Synchronous Dynamic Access Memory (DDR-SRAM) or a (Static Random Access Memory) SRAM. Further, the memory 100H2 may include a peripheral circuit such as, for example, a so-called “Arbitration circuit” for timing adjustment, a Wrapper circuit to convert Bit width, or a control circuit.

The network I/F 100H3 is an interface to connect the information processing apparatus 100 to a network such as a LAN wirelessly or via a cable. To that end, the network I/F 100H3 has a physical connection terminal having a connector shape and connection pins in compliance with a standard such as IEEE or the like. The network I/F 100H3 includes a cable for physically connecting the information processing apparatus 100 to a line, a processing circuit (not shown) to perform a process on a signal input via the connection terminal, and a driver (not shown). The information processing apparatus 100 is connected to another network or the Internet via the network 3 by the network I/F 100H3, so that data or a command can be input and output.

The CPU 100H4 is a so-called “arithmetic unit” and a control device, and performs calculations and control for the processes of the information processing apparatus 100.

For example, in order to store the image data generated by the scanner 10H1 into the memory 100H2, the CPU 100H4 controls the control ASIC 100H1 and the external bus 4.

Further, for example, in order for the printing device 10H2 to read the image data stored in the memory 100H2, the CPU 100H4 controls the control ASIC 100H1 and the external bus 4.

Further, for example, in order for the printing device 10H2 (FIG. 1) to perform image forming based on a command and image data input through the network I/F 100H3, the CPU 100H4 controls the control ASIC 100H1 and the network I/F 100H3. Further, the CPU 100H4 stores the image data, which are input through the network I/F 100H3, into the memory 100H5 described below.

The memory 100H5 is a main memory (main storage) similar to the memory 100H2. The memory 100H5 stores information such as data to be used in the calculations executed by the control ASIC 100H1. Further, the memory 100H5 may include a peripheral circuit such as, for example, a so-called “Arbitration circuit” for timing adjustment, a Wrapper circuit to convert Bit width, or a control circuit.

Here, note that the control ASIC 100H1 is not limited to an ASIC. For example, the control ASIC 100H1 may be a Programmable Logic Device (PLD) or a System in a Package (SiP). The PDL may be, for example, a Field-Programmable Gate Array (FPGA), or a Complex Programmable Logic Device (CPLD). The control ASIC 100H1 may use a Digital Signal Processor (DSP). Further, the control ASIC 100H1 may include a combination of plural ICs or plural electronic circuits. Further, the control ASIC 100H1 may include plural ICs or plural cores.

### Functional Configuration of the Information Processing Apparatus 100

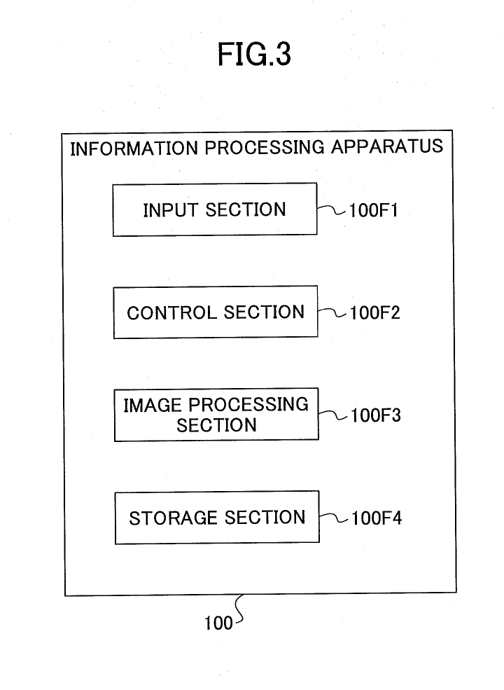

FIG. 3 is a functional block diagram of an example configuration of the information processing apparatus 100 according to an embodiment.

As illustrated in FIG. 3, the information processing apparatus 100 includes an input section 100F1, a control section 100F2, an image processing section 100F3, and a storage section 100F4.

The input section 100F1 performs a process to input data into the information processing apparatus 100. To that end, for example, the input section 100F1 performs a process to acquire the image data which are input by the network I/F 100H3 via the network 3 or a process to acquire the image data which are input by the scanner 10H1 of FIG. 1. Further, the input section 100F1 may perform a process to convert or process the input data so that the converted or processed data are in a format that can be read for a subsequent process or the converted or processed data can be rapidly processed. Such conversion includes, for example, an analog-to-digital (A/D) conversion and a YCC-to-RGB conversion. Further, in order to receive data via a network, the input section 100F1 may perform, for example, a process of removing the header data, a decryption process, a decompression process, or a decoding process.

The control section 100F2 causes the control ASIC 100H1 or the CPU 100H4 to control devices in the information processing apparatus 100 or an external device (not shown) connected to the information processing apparatus 100. To that end, for example, when the scanner 10H1 of FIG. 1 reads image data, the control section 100F2 causes the CPU 100H4 to control the external bus 4. Further, when causing the CPU 100H4 to control the external bus 4, the control section 100F2 causes the control ASIC 100H1 to control the memory 100H2, so that the memory 100H2 stores the image data.

The image processing section 100F3 causes the CPU 100H4 or a control device (not shown) of a device in the information processing apparatus 100 to perform a process to cause the image processing apparatus 10 to, for example, perform an image forming process or read an image.

The storage section 100F4 stores, for example, image data, various data, a parameter, an intermediate result of data processing, etc., into the HD 11, the memory 100H2, or the memory 100H5. Control ASIC 100H1,

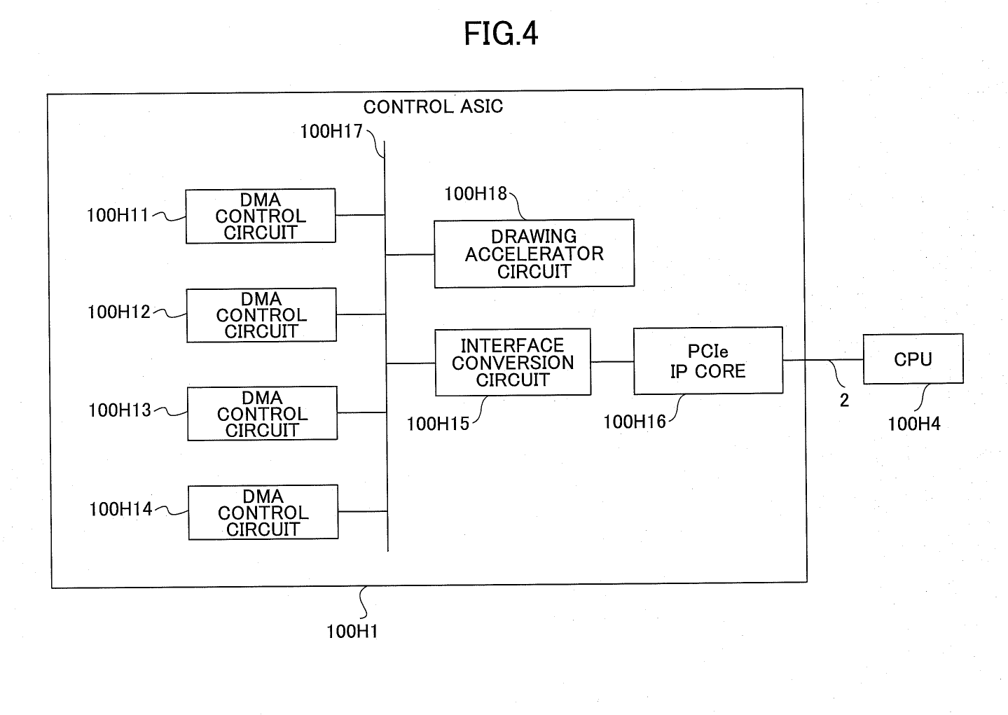

FIG. 4 is a block diagram of an example configuration of the control ASIC 100H1 according to an embodiment.

As illustrated in FIG. 4, the control ASIC 100H1 includes a Direct Memory Access (DMA) control circuit 100H11, a DMA control circuit 100H12, a DMA control circuit 100H13, and a DMA control circuit 100H14. The control ASIC 100H1 further includes an interface conversion circuit 100H15, a PCIe IP core 100H16, and a drawing accelerator circuit 100H18. Those elements of the control ASIC 100H1 are connected via an AXI bus 100H17.

The DMA control circuits 100H11 through 100H14 are a circuit that preforms a process to realize a so-called “DMA” to input and output (transfer) data and the like with the memories without intervention of the CPU 100H4.

The interface conversion circuit 100H15 performs a conversion process to convert read and write commands handled in the AXI bus 100H17 and a PCIe bus 2. The interface conversion circuit 100H15 further performs a stand-by process and a re-arranging process described below. The processes by the interface conversion circuit 100H15 are described below.

The PCIe IP core 100H16 transmits the write commands and the read commands in the PCIe bus 2. Details of the PCIe IP core 100H16 are described below.

The drawing accelerator circuit 100H18 generates drawing data to be used when, for example, the printing device 10H2 of FIG. 1 draws data into a recording medium, and transmits the generated drawing data to the printing device 10H2. However, when the drawing accelerator circuit 100H18 cannot generate the drawing data, the CPU 100H4 generates the drawing data in place of the drawing accelerator circuit 100H18 and transmits the generated drawing data to the printing device 10H2.

### Interface Conversion Circuit 100H15

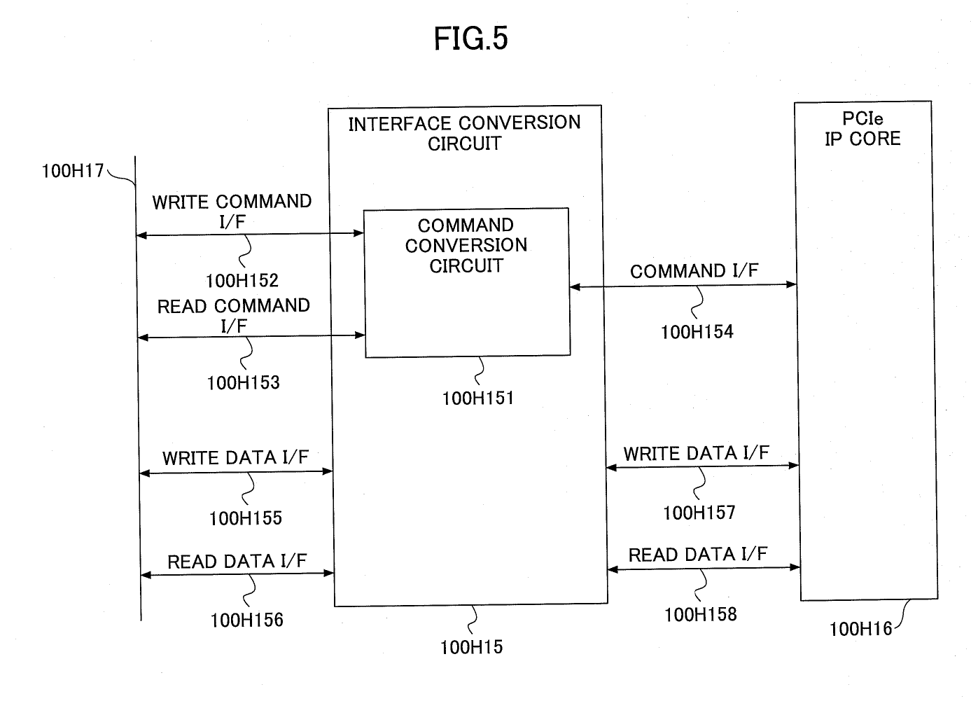

FIG. 5 is a block diagram illustrating an example configuration of the interface conversion circuit 100H15 according to an embodiment.

The interface conversion circuit 100H15 is an example of a “command unit”. In the following, the interface conversion circuit 100H15 is exemplarily described.

As illustrated in FIG. 5, the interface conversion circuit 100H15 includes a command conversion circuit 100H151. The interface conversion circuit 100H15 further includes a write data I/F 100H155, a read data I/F 100H156, a write data I/F 100H157, and a read data I/F 100H158.

The command conversion circuit 100H151 includes a write command I/F 100H152, a read command I/F 100H153, and a command I/F 100H154.

Here, regarding the commands for the PCIe bus 2, the write command, which is a command for writing, and the read command, which is a command for reading, commonly use the same I/F (i.e., the write command and the read command are transferred through the same I/F).

On the other hand, regarding the commands for the AXI bus 100H17, different (separated) I/Fs are provided for the write command and the read command, so that the write command and the read command use the different (respective) I/Fs (i.e., the write command and the read command are transferred through different I/Fs).

In this regard, the command conversion circuit 100H151 is a circuit that performs conversion so that the commands for the PCIe bus 2 and the commands for the AXI bus 100H17 are correspond with each other.

The write command I/F 100H152 is an example of a “write command unit”, and the read command I/F 100H153 is an example of a “read command unit”. In the following, the write command I/F 100H152 and the read command I/F 100H153 are exemplarily described.

The command I/F 100H154 is an example of a “read/write command unit”. In the following, the command I/F 100H154 is exemplarily described.

The write command I/F 100H152 and the read command I/F 100H153 are a command I/F for the AXI bus 100H17.

The command I/F 100H154 is a command I/F for the PCIe bus 2.

The write data I/F 100H155 and the read data I/F 100H156 are a data I/F which is for the AXI bus 100H17. The write data I/F 100H155 inputs data that are to be write in accordance with the command that is input to the write command I/F 100H152. On the other hand, the read data I/F 100H156 outputs data that are to be read in accordance with the command that is input to the read command I/F 100H153.

The write data I/F 100H157 and the read data I/F 100H158 are a data I/F which is for the PCIe bus 2.

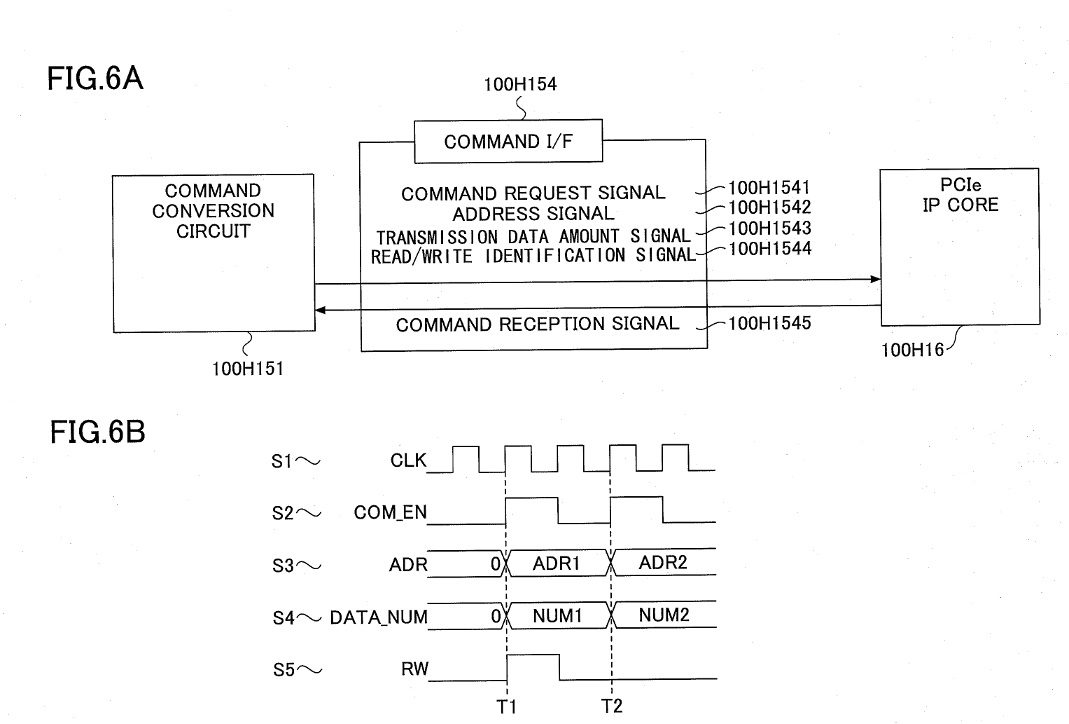

FIG. 6 illustrates an example command I/F 100H154 according to an embodiment.

FIG. 6A illustrates example signals of the command I/F 100H154 according to an embodiment.

As illustrated in FIG. 6A, the command I/F 100H154 includes (handles) signals which are output from the command conversion circuit 100H151 and input into the PCIe IP core 100H16. Also, command I/F 100H154 includes (handles) signal which is output from the PCIe IP core 100H16 and input into the command conversion circuit 100H151.

The signals output from the command conversion circuit 100H151 are input into the PCIe IP core 100H16. The signals that are input into the PCIe IP core 100H16 are, for example, a command request signal 100H1541, an address signal 100H1542, a transmission data amount signal 100H1543, and a read/write identification signal 100H1544.

FIG. 6B illustrates example signals which are output from the command conversion circuit 100H151 and input into the PCIe IP core 100H16.

The signal “CLK S1” is a clock signal to operate the circuit.

The signal “COM_EN S2” is an example signal corresponding to the command request signal 100H1541. For example, when the command request signal 100H1541 is used to request for a write or read command, the signal “COM_EN S2” is asserted High at, for example, timing “T1”.

The signal “ADR S3” is an example signal corresponding to the address signal 100H1542. Data are written or read based on addresses indicated by the signal “ADR S3”.

The signal “DATA_NUM S4” is an example signal corresponding to the transmission data amount signal 100H1543. Data are written or read in accordance with the data amount indicated by the signal “DATA_NUM S4”.

The signal “RW S5” is an example signal corresponding to the read/write identification signal 100H1544. For example, when the signal “RW S5” is high, the PCIe IP core 100H16 performs a write process. On the other than, when the signal “RW S5” is low, the PCIe IP core 100H16 performs a read process.

For example, in a case where the data whose data amount is “NUM1” is to be written from the address “ADR1”, when the signal “COM_EN S2” is asserted High at, for example, timing “T1”, the data “ADR1”, “NUM1”, and “High” are input into the signals “ADDR S3”, “DATA_NUM S4”, and “RW S5”, respectively. Further, the data to be written are input into the write data I/F 100H155 in FIG. 5.

On the other hand, for example, in a case where the data whose data amount is “NUM2” is to be read from the address “ADR2”, when the signal “COM_EN S2” is asserted High at, for example, timing “T2”, the data “ADR2”, “NUM2”, and “Low” are input into the signals “ADR S3”, “DATA_NUM S4”, and “RW S5”, respectively. After a predetermined latency, the data read from the read data I/F 100H156 in FIG. 5 are output.

The signal that is output from the PCIe IP core 100H16 and input into the command conversion circuit 100H151 is, for example, a command reception signal 100H1545.

Here, the command reception signal 100H1545 is a signal that is asserted High when the PCIe IP core 100H16 receives a command.

Note that the present invention is not limited to the commands, signals, and timings in FIGS. 6A and 6B as those for the command I/F 100H154. Namely, for example, the command I/F 100H154 may include a command or a signal which is not illustrated in FIGS. 6A and 6B. Further, the timings of the command I/F 100H154 are not limited to the timings illustrated in FIG. 6B. For example, the input timings of the signals are not limited to the same timing. For example, the timings may be adjusted by using an internal buffer (not shown). PCIe IP core 100H16

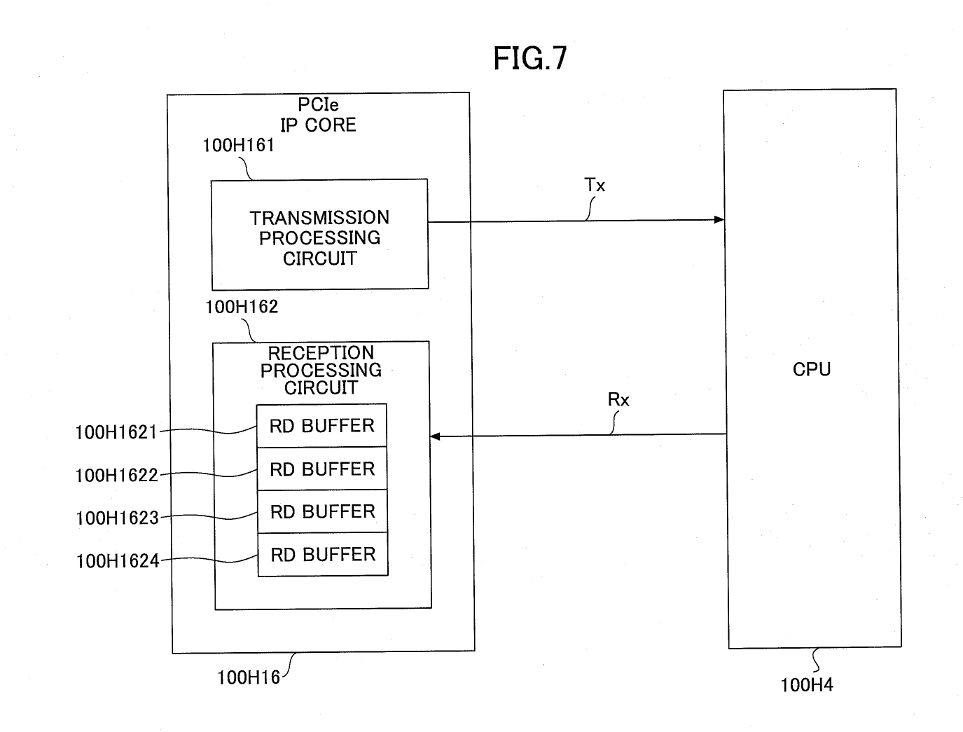

FIG. 7 is a block diagram illustrating an example PCIe IP core 100H16 according to an embodiment.

The PCIe IP core 100H16 is an example of a “read/write command unit”. In the following, the PCIe IP core 100H16 is exemplarily described.

The PCIe IP core 100H16 includes a transmission processing circuit 100H161 and a reception processing circuit 100H162.

The transmission processing circuit 100H161 of the PCIe IP core 100H16 is connected to the CPU 100H4 via a transmission signal line “Tx”. On the other hand, the reception processing circuit 100H162 of the PCIe IP core 100H16 is connected to the CPU 100H4 via a reception signal line “Rx”.

The transmission processing circuit 100H161 transmits a write command, a read command, and write data which are transmitted from the interface conversion circuit 100H15. In this case, the transmission processing circuit 100H161 transmits the commands and data based on the order and timings which are transmitted from the interface conversion circuit 100H15. Here, the transmission timing of the transmission processing circuit 100H161 may have a latency from the transmission timing of the interface conversion circuit 100H15.

The PCIe IP core 100H16 generates the command I/F 100H154, which is described with reference to FIG. 6B, and transmits the generated command I/F 100H154 to the CPU 100H4.

When the reception processing circuit 100H162 performs the read process, which is described with reference to FIG. 6B, the reception processing circuit 100H162 receives the data, which are read by the CPU 100H4 via the reception signal line “Rx”.

As illustrated in FIG. 7, the reception processing circuit 100H162 includes a RD buffer 100H1621, a RD buffer 100H1622, a RD buffer 100H1623, and a RD buffer 100H1624.

The RD buffers 100H1621 through 100H1624 store the data that are received via the reception signal line “Rx”. However, the read command, which is performed by the transmission processing circuit 100H161, may be subject to the restriction of the capacities or the number of the RD buffers 100H1621 through 100H1624.

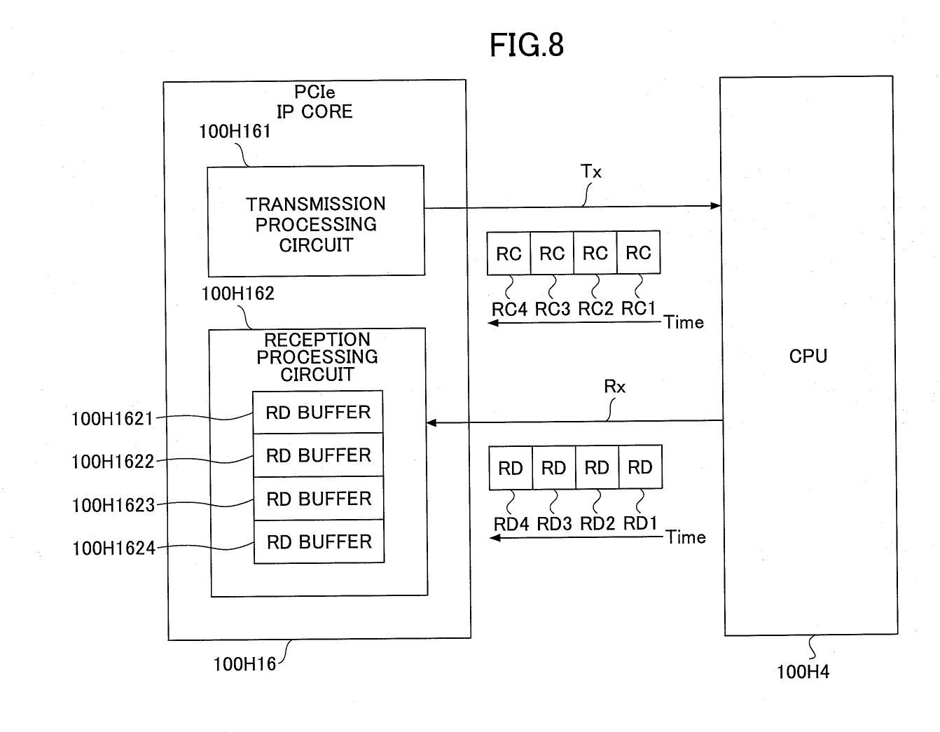

FIG. 8 is a block diagram illustrating an example data reception by the PCIe IP core 100H16.

Here, a case is described where the reception processing circuit 100H162 includes four RD buffers 100H1621 through 100H1624 as illustrated in FIG. 7.

For example, when the transmission processing circuit 100H161 transmits read commands “RC1” through “RC4” to the CPU 100H4, the CPU 100H4 outputs the read data which correspond to the read commands “RC1” through “RC4”. Here, the read data are “RD1” through “RD4”, which correspond to the read commands “RC1” through “RC4”, respectively.

Further, the read data are “RD1” through “RD4” are received after a predetermined latency has passed since the transmissions of the read commands “RC1” through “RC4”, respectively. The latency can be calculated based on, for example, a CPU processing time, time for calculating the address of the memory, and a time period from when the read execution signal is asserted to when the data are output. That is, the latency can be acquired in advance. Due to the latency, the efficiency of the read process can be improved by, for example, after transmitting the read command “RC1”, transmitting the next read command “RC2” before receiving the read data “RD1” by the PCIe IP core 100H16. Therefore, in order to make it possible to perform processes corresponding to plural read commands, plural RD buffers are provided (prepared). In other words, by providing plural RD buffers in the PCIe IP core 100H16, it becomes possible for the PCIe IP core 100H16 to process plural read commands in a parallel manner.

For example, the RD buffer has a storage area to store the maximum amount of data that is output in response to a single read command “RC”. In this case, it becomes possible that the storage area of one RD buffer can (is sufficient to) correspond to one read command “RC”. In other words, it is possible that one RD buffer can correspond to one read command “RC”. Therefore, it becomes possible for the PCIe IP core 100H16 to transmit the same number of read commands “RCs” as that of the RD buffers where no read data “RD” are stored.

The interface conversion circuit 100H15 recognizes (detects) a state of the PCIe IP core 100H16 based on the type of command that is transmitted to the PCIe IP core 100H16 and the command reception signal 100H1545 in FIG. 6. Namely, the interface conversion circuit 100H15 can recognize a “number of utilized RD buffers”. The term the “number of utilized RD buffers” herein refers to the number of RD buffers where read data “RD” are being stored. Also, the interface conversion circuit 100H15 can recognize a “number of RD buffers to be used” based on the number of the read commands “RCs” that are transmitted. The term the “number of RD buffers to be used” refers to the number of the RD buffers where the read data “RD” are to be stored. By recognizing the “number of utilized RD buffers” and the “number of RD buffers to be used”, it becomes possible to reduce the output of the data which cannot be stored in the RD buffers, thereby reducing the loss of data.

When the sum of the “number of utilized RD buffers” and the “number of RD buffers to be used” is equal to the number of RD buffers, for example, the interface conversion circuit 100H15 stops the transmission of the next read command “RC” until the “number of utilized RD buffers” is reduced.

In the following, for explanatory purposes, a case is described where the number of RD buffers is four and six read commands are continuously input from the AXI bus 100H17 into the read command I/F 100H153. Further, it is assumed that the latency, which starts when the read command “RC” is received in the read command I/F 100H153 and ends when the PCIe IP core 100H16 transmits the read command “RC” via the transmission signal line “Tx”, is two clocks. Further, it is assumed that the latency, which starts when the read command “RC” is transmitted via the transmission signal line “Tx” and ends when the reception processing circuit 100H162 receives the corresponding read data “RD”.

### Stand-by Process

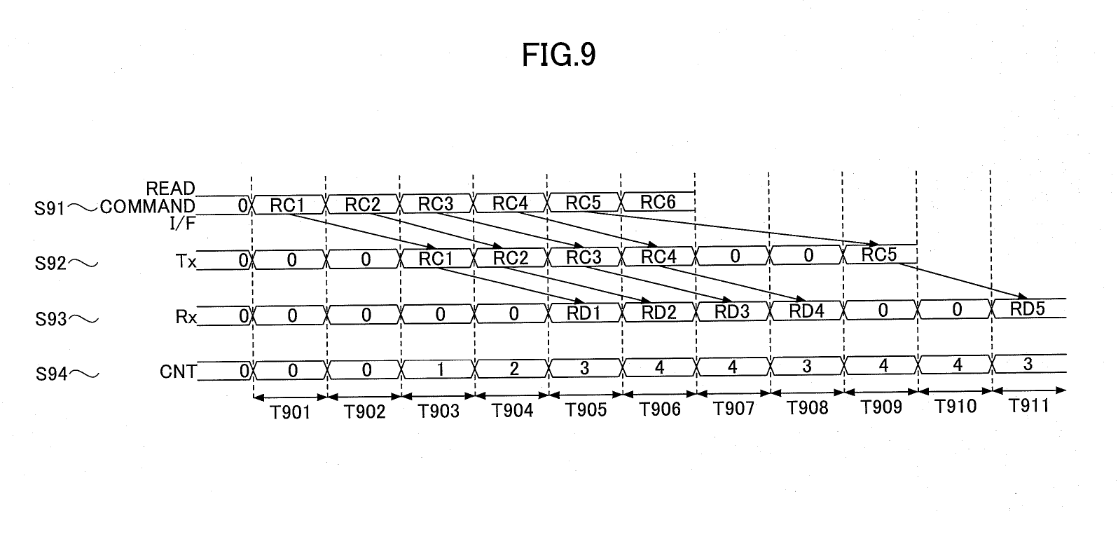

FIG. 9 is a timing chart illustrating an example stand-by process according to an embodiment.

In FIG. 9, the read command I/F S91 refers to a signal indicating a command input from the AXI bus 100H17. The read command I/F S91 corresponds to the read command I/F 100H153 in FIG. 5. The read command I/F S91 in FIG. 9 indicates a case where read commands “RC1” through “RC6” are sequentially input from the AXI bus 100H17.

Further, the Tx S92 in FIG. 9 refers to a signal transmitted by the PCIe IP core 100H16 to the CPU 100H4 via the transmission signal line “Tx” based on the read command “RD” input to the read command I/F S91. The Tx S92 signal is transmitted in the transmission signal line “Tx” in FIG. 7.

Here, the latency with respect to the input to the read command I/F S91 is two clocks. In this case, for example, the Tx S92 signal (“RC1”), which corresponds to the read command “RC1” input to the read command I/F S91 at timing “T901”, is transmitted at timing “T903”.

Further, the Rx S93 in FIG. 9 refers to the read data “RD” signal transmitted by the CPU 100H4 to the reception processing circuit 100H162 in response to the read command “RC” transmitted in the Tx S92 signal. The Rx S93 signal is transmitted via the reception signal line “Rx”. Here, the latency with respect to the transmission of the Tx S92 signal is two clocks.

In this case, for example, the Rx S93 signal (“RD1”), which corresponds to the read command “RC1” input to the read command “RC1” transmitted at timing “T903”, is received by the reception processing circuit 100H162 at timing “T905”.

Further, the CNT S94 in FIG. 9 refers to a data signal indicating the sum of the “number of utilized RD buffers” and the “number of RD buffers to be used”. For example, the CNT S94 signal at timing “T903” indicates “1”, because the sum of “0”, which is the number of the RD buffers that are being used, and “1”, which is the number of RD buffer that is to be used based on (because of) the read command “RC1” transmitted in the Tx S92 signal, is “1”.

In this regard, the number indicated in the CNT S94 signal is reduced when the use of the RD buffer is finished. For example, when the use of the read data “RD1”, which is received at timing “T905”, is finished in 2 clocks, the reception processing circuit 100H162 can use the RD buffer, that was used for storing the read data “RD1”, at timing “T908”. Therefore, the CNT S94 signal at timing “T908” indicates “3”, because the sum of “3”, which is the number of the RD buffers that are being used, and “0”, which is the number of RD buffers that is to be used, is “3”.

When the number indicated by the CNT S94 signal reaches “4” which is the number of RD buffers, the interface conversion circuit 100H15 stops the transmission of the next read command “RC5” until the “number of utilized RD buffers” is reduced. To that end, for example, the interface conversion circuit 100H15 may have a First-In First-Out (FIFO) buffer (not shown) to store the read commands “RC” to be transmitted so as to stop (wait) the transmission of the read command “RC5”.

For example, at timing “T908”, the interface conversion circuit 100H15 determines that the “number of utilized RD buffers” is reduced. By the stand-by process to stop the transmission of the read command “RC5” before the timing “T909”, it becomes possible for the interface conversion circuit 100H15 to prevent the overwriting by the read data “RD5”, thereby reducing the loss of data.

### Re-Arranging Process

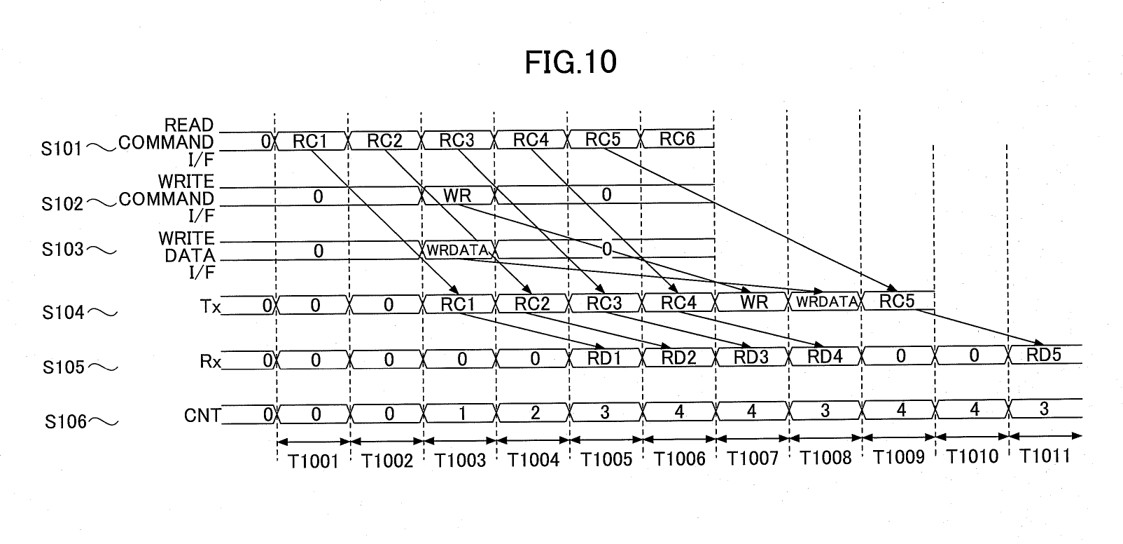

FIG. 10 is a timing chart illustrating an example re-arranging process according to an embodiment.

The re-arranging process herein refers to a process performed by the interface conversion circuit 100H15 in FIG. 5 to re-arrange (change the order of) the commands or the data that are received by the write command I/F 100H152, the read command I/F 100H153, and the write data I/F 100H155. The re-arranged commands or data are transmitted to the PCIe IP core 100H16 by the command I/F 100H154 in FIG. 5. The PCIe IP core 100H16 in FIG. 5 transmits the commands or data based on the timings and the order transmitted by the command I/F 100H154 in FIG. 5.

The read command I/F S101 in FIG. 10 refers to a signal indicating the commands input from the AXI bus 100H17 similar to the read command I/F S91 in FIG. 9. The read command I/F S101 corresponds to the read command I/F 100H153 in FIG. 5. Similar to the case of FIG. 9, FIG. 10 illustrates the case where read commands “RC1” through “RC6” are input from the AXI bus 100H17 to the read command I/F S101.

The write command I/F S102 in FIG. 10 refers to a signal indicating the commands input from the AXI bus 100H17 similar to the read command I/F S101. The write command I/F S102 corresponds to the write command I/F 100H152 in FIG. 5. FIG. 10 illustrates the case where a write command “WR” is input from the AXI bus 100H17 at timing “T1003”.

The write data I/F S103 refers to a signal indicating the write data input from the AXI bus 100H17 similar to the write command I/F S102. The write data I/F S103 corresponds to the write data I/F 100H155 in FIG. 5. FIG. 10 illustrates the case where write data “WRDATA”, which corresponds to the write command “WR” input from the AXI bus 100H17 to the write command I/F S102, are input.

The interface conversion circuit 100H15 of FIG. 5 performs the re-arranging process on the commands that are input to the read command I/F S101 and the write command I/F S102 and the data that are input to the write data I/F S103, and transmits the re-arranged commands and data to the PCIe IP core 100H16 in FIG. 5.

The Tx S104 refers to a signal that is generated based on the read command “RC”, the write command “WR”, and the write data “WRDATA” that are input in the read command I/F S101, the write command I/F S102, and the write data I/F S103, respectively. Further, the Tx S104 refers to a signal that is transmitted to the CPU 100H4 via the transmission signal line “Tx” by the PCIe IP core 100H16. Similar to the case of FIG. 9, the latency with respect to the input of the read command I/F S101 is two clocks. According to the latency, for example, the signal of the Tx S104, which corresponds to the read command “RC1” input by the read command I/F S101 at timing “T1001”, is transmitted at timing “T1003”.

The Tx S104 of FIG. 10 illustrates a case where the read command “RC” is transmitted with higher priority than the write command “WR”. In this case, when there exists a read command “RC” which is not yet transmitted, the transmission of the write command “WR” is stopped (stood by) until the transmission of the read command “RC” is completed.

The Rx 5105 in FIG. 10 refers to a signal of the read data “RD” which is transmitted to the reception processing circuit 100H162 by the CPU 100H4 in response to the read command “RC” transmitted in the Tx S104. The latency with respect to the transmission of the Tx S104 is two clocks. Therefore, for example, when the signal of Rx 5105 in response to the read command “RC1” transmitted at timing “T1003” is received by the reception processing circuit 100H162 at timing “T1005”.

The CNT S106 refers to a signal indicating the sum of the “number of utilized RD buffers” and the “number of RD buffers to be used”, similar to the CNT S94 in FIG. 9.

In order to perform the stand-by process described with reference to FIG. 9, the interface conversion circuit 100H15 stops the transmission of the read command “RC5” before the timing “T1009”.

When the stand-by process described with reference to FIG. 9 is performed, the interface conversion circuit 100H15 performs the re-arranging process to re-arrange (change) the order of the transmission of the read command “RC” and the transmission of the write command “WR”. The re-arranging process in this case is to re-arrange (change) the transmission order by placing a higher transmission priority on the write command “WR”, so that the write command “WR” and the write data “WRDATA”, which are originally scheduled to be transmitted after the transmission of the read commands “RC5” and “RC6”, are transmitted earlier than the transmission of the read commands “RC5” and “RC6”.

Unlike the transmission of the read command “RC”, it is not necessary to receive data in response to the transmission of the write command “WR” and the write data “WRDATA”. Therefore, it is not necessary to secure (use) any RD buffer. In other words, even when the write command “WR” and the write data “WRDATA” are transmitted without securing available RD buffers (RD buffers to be used), the data is unlikely to be lost.

In the re-arranging process according to an embodiment, it becomes possible to use the bus which is not being used by the stand-by process and improve the bus throughput.

The interface conversion circuit 100H15 in FIG. 5 performs the re-arranging process and transmits the commands and the data on which the re-arranging process has been performed to the PCIe IP core 100H16. The PCIe IP core 100H16 transmits the write command “WR” and the write data “WRDATA” at timings “T1007” and “T1008”, respectively. Namely, in the setting where the write command “WR” is to be preferentially transmitted and the re-arranging process is to be performed, the PCIe IP core 100H16 can transmit the write command “WR” and the write data “WRDATA” at timings “T1007” and “T1008”, respectively. Specifically, in a case of FIG. 10, it becomes possible to transmit the write command “WR” and the write data “WRDATA” faster than the case where the write command “WR” and the write data “WRDATA” are transmitted after the transmission of the read commands “RC5” and “RC6” by two clocks, thereby reducing the processing time of the transmission of the write command “WR” and the write data “WRDATA” by two clocks.

Accordingly, by performing the re-arranging process, it becomes possible for the control ASIC 100H1 to improve the throughput of the processes of transmitting the read commands “RC1” through “RC6”, the write command “WR”, and the write data “WRDATA”.

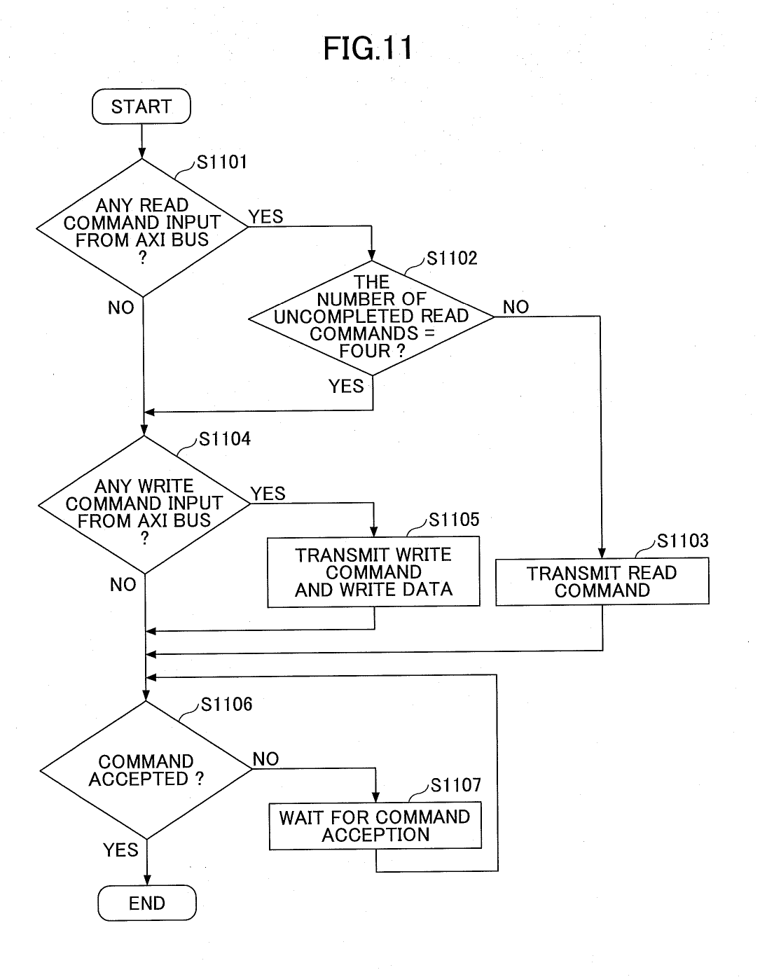

FIG. 11 is a flowchart of an example transmission and the re-arranging process according to an embodiment.

As illustrated in FIG. 11, in step S1101, the interface conversion circuit 100H15 in FIG. 5 determines whether the read command “RC” is input. When the interface conversion circuit 100H15 determines that the read command “RC” is input (YES in step S1101), the process goes to step S1102. The case where the interface conversion circuit 100H15 determines that the read command “RC” is input corresponds to the case in timings “T1001” through “T1006” of FIG. 10. On the other hand, when the interface conversion circuit 100H15 determines that the read command “RC” is not input (NO in step S1101), the process goes to step S1104. The case where the interface conversion circuit 100H15 determines that the read command “RC” is not input corresponds to the case in the timings before the timing “T1001”.

In step S1102, the interface conversion circuit 100H15 in FIG. 5 further determines whether the number of uncompleted read commands is four.

Here, the case where the interface conversion circuit 100H15 determines that the number of uncompleted read commands is four (YES in step S1102) refers to the case where the all of the four RD buffers 100H1621 through 100H1624 in FIG. 8 are being used. In this case, due to the stand-by process described above, the interface conversion circuit 100H15 in FIG. 5 stops the transmission of the read command “RC”, the process goes to step S1104, where the process of the write command is performed. Here, the case where the interface conversion circuit 100H15 determines that the number of uncompleted read commands is four corresponds to the case in the timing “T1006” of FIG. 10.

On the other hand, when the interface conversion circuit 100H15 determines that the number of uncompleted read commands is not four (NO in step S1102), at least one of the four RD buffers 100H1621 through 100H1624 is available (can be used). In this case, the PCIe IP core 100H16 transmits the read command “RC”. In this case, even when the read data “RD” in response to the read command “RC” are received, it is unlikely to lose data. Therefore, the process goes to step S1103. Here, the case where interface conversion circuit 100H15 determines that the number of uncompleted read commands is not four in step S1102 corresponds to, for example a case in timings “T1001” through “T1005” of FIG. 10.

The re-arranging process can be realized by, for example, the process in step S1102.

In step S1103, the interface conversion circuit 100H15 in FIG. 5 transmits the read commands “RC” to the PCIe IP core 100H16 based on the input read commands. The PCIe IP core 100H16 transmits the read commands “RC” by the Tx S104 based on the transmission order and timings from the interface conversion circuit 100H15. The step S1103 corresponds to the case where, for example, the read command “RC1” is transmitted by the Tx S104 at the timing “T1003” in FIG. 10.

In step S1104, the interface conversion circuit 100H15 in FIG. 5 determines whether the write command “WR” is input. When the interface conversion circuit 100H15 determines that the write command “WR” is input (YES in step S1104), the process goes to step S1105.

On the other hand, when the interface conversion circuit 100H15 determines that the write command “WR” is not input (NO in step S1104), the process goes to step S1106. The case where the interface conversion circuit 100H15 determines that the write command “WR” is not input corresponds to, for example, the case in timing “T1001” of FIG. 10 where no write command “WR” is input in the write command I/F S102.

In step S1105, the interface conversion circuit 100H15 in FIG. 5 transmits the write commands “WR” to the PCIe IP core 100H16 based on the input write commands. The PCIe IP core 100H16 in FIG. 5 transmits the write command “WR” and write data “WRDATA” via the transmission signal line “Tx”. The case in step S1105 corresponds to the case where, for example, the write command “WR” and the write data “WRDATA” are transmitted at timings “T1007” and “T1008”, respectively, by the Tx S104 signal in FIG. 10.

In step S1106, the interface conversion circuit 100H15 in FIG. 5 determines whether the command is accepted. Specifically, the interface conversion circuit 100H15 in FIG. 5 determines whether the command or data transmitted to the PCIe IP core 100H16 are received by the PCIe IP core 100H16. Namely, the interface conversion circuit 100H15 in FIG. 5 determines whether the PCIe IP core 100H16 transmitted the command or data or not.

In this case, whether the command or data are received by the PCIe IP core 100H16 is determined based on the command reception signal 100H1545 in FIG. 5.

When the interface conversion circuit 100H15 in FIG. 5 determines that the command or data transmitted to the PCIe IP core 100H16 are received by the PCIe IP core 100H16 based on the command reception signal 100H1545 in FIG. 5 (YES in step S1106), the process ends. On the other hand, when the interface conversion circuit 100H15 in FIG. 5 determines that the command or data transmitted to the PCIe IP core 100H16 are not received by the PCIe IP core 100H16 based on the command reception signal 100H1545 in FIG. 5 (NO in step S1106), the process goes to step S1107.

In step S1107, the interface conversion circuit 100H15 in FIG. 5 performs a process to wait for command acceptance. After stopping processes for a predetermined time period (in step S1107), the goes back to step S1106, so that the interface conversion circuit 100H15 in FIG. 5 determines whether the command is accepted.

Here, the number of uncompleted read commands may be determined based on, for example, the CNT S106 signal in FIG. 10.

Further, the number of transmittable read commands may be changed by the setting of the control ASIC 100H1.

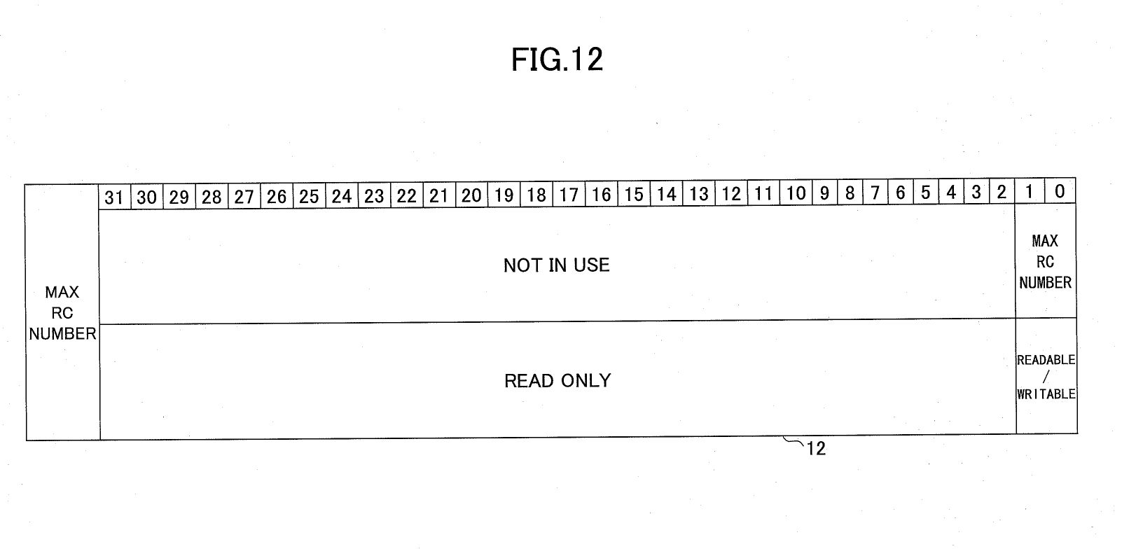

FIG. 12 illustrates an example register of the control ASIC 100H1 according to an embodiment.

The control ASIC 100H1 includes, for example, a register 12 (FIG. 12). The register 12 is an example of a memory unit. In the following, the register 12 is described as an example of the memory unit. The register 12 is, for example, a 32-bit register. The register 12 is used to input a value to set the number of transmittable read commands. Here, the term “number of transmittable read commands” refers to a value that is calculated by adding “1” to the value that is input into the “MAX RC NUMBER” of the register 12. In a case where the number of the RD buffers is four as described with reference to FIG. 7, the number of transmittable read commands is in a range of 1 to 4. In this case, the data amount of the “MAX RC NUMBER” is two bits, so that a value in a range of 0 to 3 can be set. The register 12 in FIG. 12 illustrates a case where the lower two bits among the 32 bits are allocated to the “MAX RC NUMBER”. The interface conversion circuit 100H15 in FIG. 5 may change the value that is to be used in the determination in step S1102 based on a value that is calculated by adding “1” to the value that is set in the “MAX RC NUMBER” of the register 12.

Depending on the system including the control ASIC 100H1, the performances of the read function and the write function may be different. For example, in a case where a value “2” is set to the value of the “MAX RC NUMBER” of the register 12, in step S1102, the interface conversion circuit 100H15 in FIG. 5 determines whether the number of the uncompleted read commands is three. In this case, when compared with the case where the interface conversion circuit 100H15 in FIG. 5 determines whether the number of the uncompleted read commands is four in step S1102, it may become possible to increase the frequency of transmission of the write commands rather than the transmission of the read commands. Namely, it may become possible to improve the write performance based on the setting of the register 12.

Here, it should be noted that the present invention is not limited to an information processing apparatus having two buses. Namely, the present invention may also be applied to an information processing apparatus having three or more buses.

As described above, according to an embodiment of the present invention, it may become possible to improve the throughput in reading and writing processes in an apparatus that includes two separated buses and one common bus, one of the two separated buses being for inputting write commands and the other of the two separated buses being for inputting read commands, and the one common bus being for inputting both the write commands and read commands (FIG. 5).

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus including first and second buses, comprising:
a read/write command unit configured to transmit a read command or a write command to the first bus;
a read command unit configured to receive a read command from the second bus;
a write command unit configured to receive a write command from the second bus; and
a command unit configured to transmit the read command and the write command to the read/write command unit based on the read command received by the read command unit and the write command received by the write command unit,
wherein the command unit is configured to
perform a stand-by process to stop transmitting the read command, and
perform a re-arranging process to, while stopping transmitting the read command, change a transmission order of the read command and the write command so that the read/write command unit transmits the write command with higher priority than the read command.

2. The information processing apparatus according to claim 1,
wherein the command unit is configured to perform the stand-by process based on a number of uncompleted read commands.

3. The information processing apparatus according to claim 1,
wherein the write command includes data to be written based on the write command.

4. The information processing apparatus according to claim 1, further comprising:
a memory unit configured to store a value for a setting,
wherein the command unit is configured to perform the stand-by process based on the value.

5. An information processing method for an information processing apparatus that includes
first and second buses,
a read/write command unit transmitting a read command or a write command to the first bus,
a read command unit receiving a read command from the second bus, and
a write command unit receiving a write command from the second bus, the method comprising:
a command step of transmitting the read command and the write command to the read/write command unit based on the read command received by the read command unit and the write command received by the write command unit,
wherein in the command step,
a stand-by process is performed to stop transmitting the read command, and
a re-arranging process is preformed to, while stopping transmitting the read command, change a transmission order of the read command and the write command so that the read/write command unit transmits the write command with higher priority than the read command.
